(19) United States
(12) Patent Application Publication
(10) Pub. No.: US 2009/0326950 A1
(43) Pub. Date: Dec. 31, 2009

(54) Voice waveform interpolating apparatus and method

(75) Inventor: Chikako Matsumoto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/585,005

(22) Filed: Aug. 31, 2009

Related U.S. Application Data
(63) Continuation of application No. PCT/JP2007/054849, filed on Mar. 12, 2007.

(51) Int. Cl. G10L 13/00

(52) U.S. Cl. 704/265; 704/E13.002

(57) ABSTRACT

A voice waveform interpolating apparatus for interpolating part of stored voice data by another part of the voice data so as to generate voice data. To achieve this, it comprises a voice storage unit, an interpolated waveform generation unit generating interpolated voice data, and a waveform combining unit outputting voice data, a part of the voice data is replaced with another part of the voice data, and further comprises an interpolated waveform setting function unit judging if the other part of the voice data is appropriate as interpolated voice data to be generated by the interpolated waveform generation unit.

### CROSS-REFERENCE TO RELATED APPLICATION

This application is a continuation application based on International Application No. PCT/JP2007/054849, filed on Mar. 12, 2007, the contents being incorporated herein by reference.

### FIELD

The embodiments discussed herein relate to a voice waveform interpolating apparatus, for example, a voice waveform interpolating apparatus used when reproducing, in a receiving side, a voice waveform corresponding to a voice packet lost during transmission of voice packets in a packet communication system. The embodiments further relate to, for example, a voice waveform interpolating apparatus useable in voice editing or processing systems such as ones editing or processing data of stored phoneme pieces to generate new voice data.

Note that in the following, the voice packet communication system of the former embodiments will be explained as an example.

### BACKGROUND

In recent years, due to the spread of the Internet, so-called VoIP (Voice over IP) communication systems transmitting voice data packetized into voice packets through an IP (Internet Protocol) network have been rapidly spreading in use.

If part of the voice packets to be received is lost or dropped in an IP network transmitting PCM data packet units as above, the voice quality of the voice reproduced by the voice packets will deteriorate. Therefore, a variety of methods for preventing as much as possible the user from noticing the deterioration in the voice quality caused by the loss etc. of voice packets have been proposed in the past.

As one voice packet loss concealment method, there is already known the ITU-T (International Telecommunication Union) Recommendation G.711 Appendix I. In the packet loss concealment method stipulated in the G.711 Appendix I, first, the pitch period, a physical property of voice, is extracted using waveform correlation. The extracted pitch pattern is repeatedly arranged at the parts corresponding to the lost voice packets to generate a loss concealment signal. Note that the loss concealment signal is made to gradually attenuate when voice packet loss occurs continuously.

Further, several interpolated reproduction methods for voice loss have been proposed. For example, there are the following Patent Literature 1 to Patent Literature 3.

Patent Literature 1 discloses a method of imparting fluctuations in pitch period and power fluctuations, estimated from voice data that had been normally received prior to packet loss, to generate a loss concealment signal. Further, Patent Literature 2 discloses a method of referring to at least one of the packets before packet loss and packets after packet loss and utilizing their pitch fluctuation characteristics and power fluctuation characteristics to estimate the pitch fluctuation and power fluctuation of the voice loss segment. Further, it discloses a method of reproducing the voice waveform of a voice loss segment by using these estimated characteristics. Further, Patent Literature 3 discloses a method of calculating an optimal matching waveform with a signal of voice packets input prior to loss by a non-standard differential operation and determining an interpolated signal in which the signal of the voice packets input prior to loss is interpolated based on the minimum value of the calculated results.

Patent Literature 1: Japanese Laid-open Patent Publication No. 2001-228896

Patent Literature 2: International Publication Pamphlet No. WO2004/068098

Patent Literature 3: Japanese Laid-open Patent Publication No. 02-4062

According to the above conventional methods for waveform interpolation of voice loss, a waveform is extracted from immediately before or immediately after a lost packet, its pitch period is extracted, and the pitch waveform is repeated so as to generate an interpolated voice waveform. In this case, as the waveform is extracted from immediately before or immediately after the lost packet, regardless of the type of the extracted waveform, the pitch waveform is repeated in the same way in all cases to generate an interpolated voice waveform.

If the immediately proceeding waveform used in generating the above waveform of the interpolated voice is a steady waveform having an amplitude of a constant level or greater and a low amplitude fluctuation such as in for example the vicinity of the middle of a vowel, a voice waveform with almost no voice quality deterioration can be generated. However, if packet loss occurs at, for example, a transition part at which the formant greatly changes from a vowel to a consonant or at the end of a breath group etc., there are cases where even if the above waveform used in the generation of the interpolated voice waveform is a cyclic waveform having high self-correlation, the waveform will become reproduced noise like a buzzing noise and cause sound deterioration. This is shown in the illustrations.

FIGS. 14A and 14B are views respectively illustrating a waveform A of a transmitted voice and an interpolated voice waveform B in which the part of the transmitted voice waveform A that is missing due to loss of a voice packet is interpolated. In FIG. 14A, the part of a sequence of voice waveforms in which a voice packet is missing due to packet loss is illustrated as Pa. According to the above conventional methods, the packet Pb that is always immediately before the missing part Pa is inserted as a repeated packet Pb′ in the missing part Pa as illustrated in FIG. 14B.

The waveform of Pb′ is at a glance a clean waveform, but if it is reproduced as an actual voice, it will become a buzzing sound that is uncomfortable for the user.

### SUMMARY

According to an aspect of the embodiments, the apparatus may be a voice waveform interpolating apparatus which does not generate unpleasant reproduction sounds.

Further, a voice waveform interpolating method for accomplishing this and a voice waveform interpolating program for a computer may be provided.

The above apparatus, as explained using the following figures, comprises:

(i) a voice storage unit storing voice data,

(ii) an interpolated waveform generation unit generating voice data in which a part of the voice data is interpolated by another part of the voice data,

(iii) a waveform combining unit combining voice data from the voice storage unit with interpolated voice data from the interpolated waveform generation unit replacing part of the same, and

(iv) an interpolated waveform setting function unit judging if a part of the voice data is appropriate as interpolated voice data for interpolation in the interpolated waveform generation unit, selecting the voice data that is deemed appropriate, and setting this voice data as the interpolated voice data. Among these, the interpolated waveform setting function unit of the above (iv) may be a characterizing constituent.

This interpolated waveform setting function unit (iv) includes, in further detail, an amplitude information analyzing part analyzing the amplitude information for the voice data from the voice storage unit and a voice waveform judging unit judging based on the analysis results if this voice data is appropriate as the interpolated voice data.

In further detail, the amplitude information per frame unit of the voice data is calculated to find the amplitude envelope from the amplitude value of the time direction, and the position on the amplitude envelope of the neighboring waveform to be used in waveform interpolation is identified based on this amplitude envelope. It is judged in the above voice waveform judging unit from the amplitude information of this identified position if this is a waveform appropriate for repetition as in the above.

### BRIEF DESCRIPTION OF DRAWINGS

FIG. 1 is a view illustrating the general structure of an embodiment.

FIG. 2 is a view illustrating in more detail the general structure of FIG. 1.

FIGS. 3A, 3B, and 3C are views illustrating a waveform A similar to the waveform of FIG. 14A, a voice waveform B of a longer period of time including the waveform A in the middle, and an amplitude envelope C obtained by the calculation of the amplitude value of the waveform B.

FIG. 4 is a view illustrating a first example of a voice waveform interpolating apparatus in a packet communication system.

FIGS. 5A and 5B are views respectively illustrating a voice waveform A similar to the waveform of FIG. 14A and a voice waveform B interpolated from the background noise segment.

FIGS. 6A and 6B are views respectively illustrating a waveform A similar to the waveform of FIG. 14A and a voice waveform B interpolated by the succeeding voice data.

FIG. 7 is a view illustrating a second example of a voice waveform interpolating apparatus.

FIG. 8 is a flowchart illustrating the operation of the voice waveform interpolating apparatus depicted in FIG. 7.

FIG. 9 is a flowchart illustrating step S19 depicted in FIG. 8 in further detail.

FIG. 10 is a view illustrating a third example of a voice waveform interpolating apparatus.

FIG. 11 is a view illustrating a fourth example of a voice waveform interpolating apparatus.

FIGS. 12A and 12B are views respectively illustrating an example A in which the waveform of FIG. 14A is transformed and a voice waveform B interpolated from the preceding voice data.

FIG. 13 is a flowchart illustrating the operations when performing waveform interpolation such as depicted in FIGS. 6A and 6B and FIGS. 12A and 12B.

FIGS. 14A and 14B are views respectively illustrating a transmitted voice waveform A and an interpolated voice waveform B in which a part of the waveform of the transmitted voice waveform A, missing due to voice packet loss, is interpolated.

### DESCRIPTION OF EMBODIMENTS

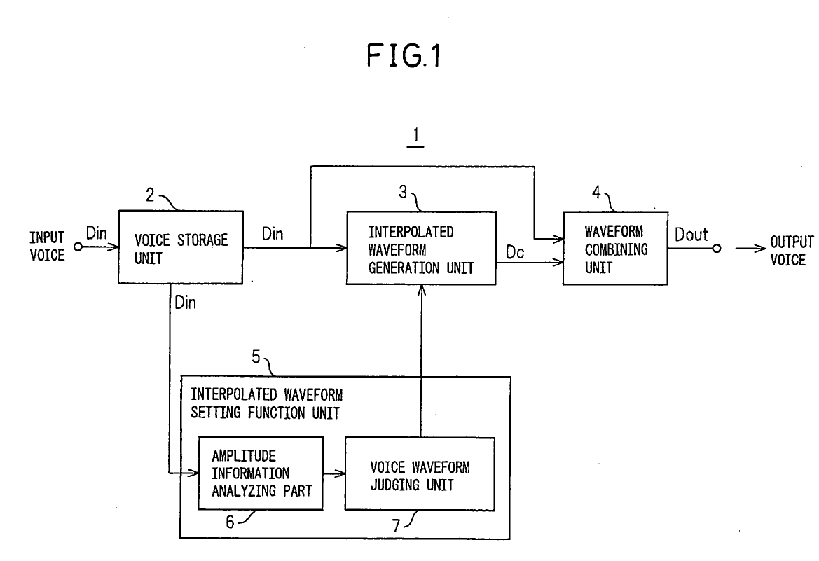

FIG. 1 is a view illustrating the basic structure of an embodiment. As depicted in this figure, a voice waveform interpolating apparatus 1 comprises a voice storage unit 2 storing voice data Din, an interpolated waveform generation unit 3 generating voice data Dc interpolating a part of the voice data Din by another part of the voice data Din, a waveform combining unit 4 combining the voice data Din from the voice storage unit 2 with the interpolated voice data Dc from the interpolated waveform generation unit 3 replacing part of the voice data Din and outputting the result as voice data Dout, and an interpolated waveform setting function unit 5 judging if a part of the above voice data Din is appropriate as interpolated voice data for interpolation in the interpolated waveform generation unit 3, selecting the voice data that is deemed appropriate, and setting it as the interpolated voice data Dc.

Here, the interpolated waveform setting function unit 5 includes an amplitude information analyzing part 6 analyzing the amplitude information for the voice data Din from the voice storage unit 2 and a voice waveform judging unit 7 judging if the interpolated voice data Dc is appropriate based on the analysis results.

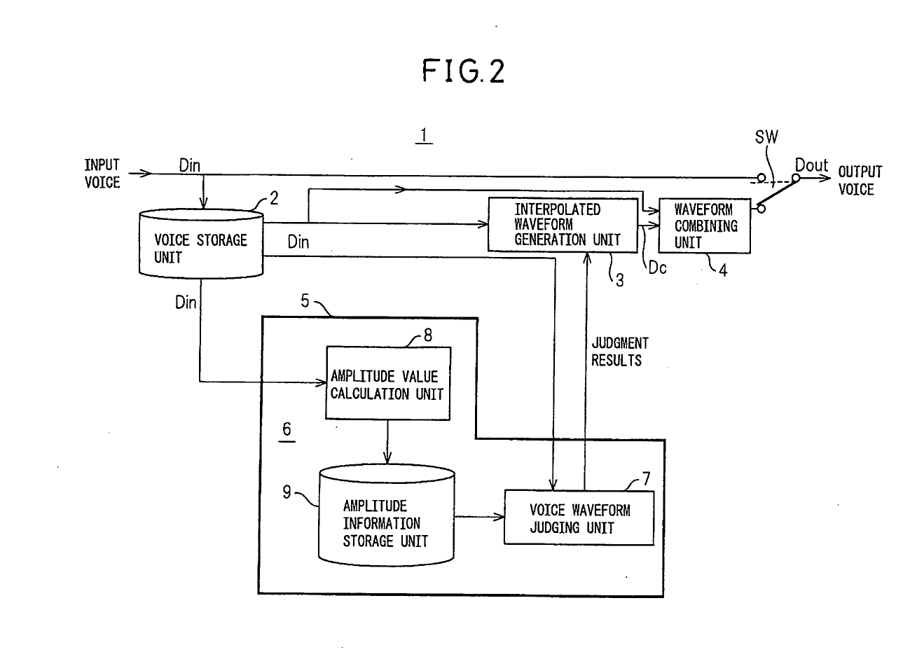

FIG. 2 is a view illustrating in more detail the basic structure of FIG. 1. Note that, throughout the figures, similar component elements are depicted assigned the same reference numerals or symbols.

In FIG. 2, the amplitude information analyzing part 6 of FIG. 1 is depicted in further detail. That is, the amplitude information analyzing part 6 comprises an amplitude value calculation unit 8 calculating the amplitude value of the voice data Din to obtain the amplitude value of the time direction and an amplitude information storage unit 9 temporarily storing the calculated amplitude value as amplitude information. This amplitude value calculation unit 8 also calculates the amplitude envelope and the maximum and minimum values of the amplitude.

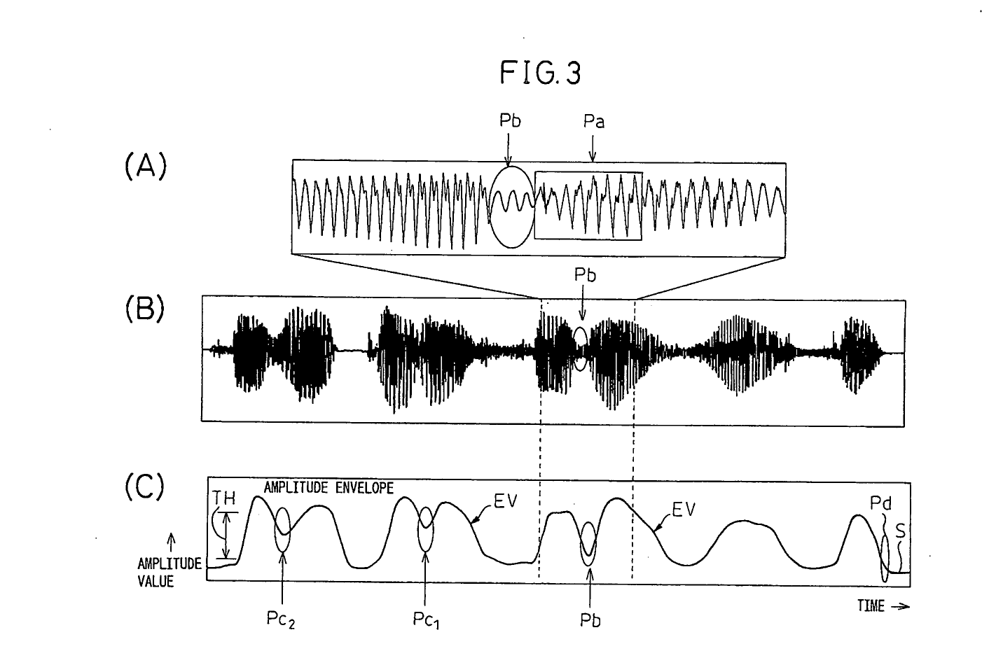

Here, the voice waveform judging unit 7 judges if the interpolated voice data Dc is appropriate according to the position of the amplitude envelope specified from the amplitude information of the time direction. Note that the “SW” illustrated in the upper right of this figure is a switch for transmitting the input voice data Din as the output voice data Dout as it is or alternatively switching it to voice data including the interpolated voice data Dc from the waveform combining unit 5 obtained by interpolation. Here, to facilitate understanding of the principle of the embodiments, FIG. 3 is referred to.

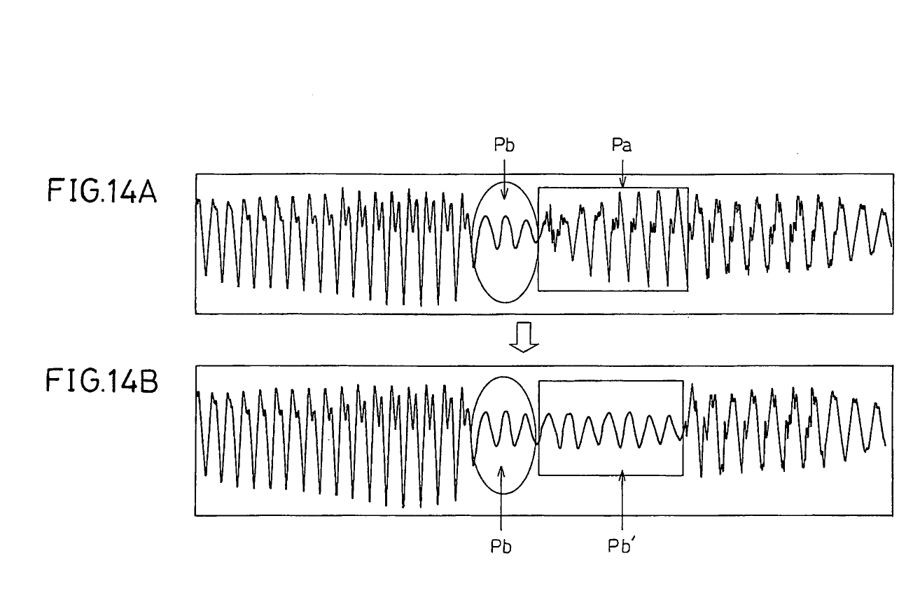

FIGS. 3A, 3B, and 3C are views illustrating a waveform A similar to FIG. 14A, a voice waveform B covering a longer period of time including the middle of the waveform A, and an amplitude envelope C obtained by amplitude value calculation (8) from the waveform B. When voice packet loss occurs in a part of Pa of FIG. 3A, it is judged in the voice waveform judging unit 7 if the voice waveform Pb corresponding to the packet immediately before the lost packet is appropriate as an interpolated waveform Dc.

In order to explain the judgment method of this voice waveform judging unit 7, FIGS. 3B and 3C are referred to. The voice waveform judging unit 7 judges the appropriateness of interpolated waveform from interpolated waveform candidates based on the results of analysis of the input data Din (illustrated as an analog waveform in FIG. 3B) by the amplitude information analyzing part 6, i.e. by inputting the amplitude envelope EV (illustrated as an analog format in FIG. 3C) to the voice waveform judging unit 7.

In this case, at what positions on the amplitude envelope EV the candidates are located are the judgment criteria. Here, if analyzing the amplitude envelope EV of FIG. 3C, it is found that the voice waveform of the Pb part is positioned where the amplitude is locally small and cannot be a candidate for the above interpolated waveform. Further, the voice waveforms of the Pc1 part and Pc2 part are positioned at relative minimums on the amplitude envelope and cannot be candidates for the above interpolated waveform. Further, the Pd part voice waveform is positioned immediately before the unvoiced segment S on the amplitude envelope and cannot be a candidate for the interpolated waveform. If the voice waveform positioned at any one of Pb, Pc1, Pc2, and Pd is used as an interpolated waveform, noise such as the already mentioned buzzing sound will be reproduced. Here, waveforms not positioned at Pb, Pc1, Pc2, Pd, etc. are selected as waveforms on the amplitude envelope (EV) of FIG. 3C used as interpolated waveforms in the interpolated waveform generation unit 3.

A voice interpolating apparatus used in a voice editing/processing system and a voice waveform interpolating apparatus used in a packet communication system is realized by the principle of the above embodiment.

The voice waveform interpolating apparatus used in the former voice editing or processing system comprises a voice storage unit 2 storing a plurality of phoneme pieces, an interpolated waveform generation unit 3 generating voice data Dc in which a part of a series of voice data Din is interpolated by the repeated use of the phoneme pieces, a waveform combining unit 4 combining voice data stored in the voice storage unit 2 with interpolated voice data from the interpolated waveform generation unit 4 replacing part of that voice data, and an interpolated waveform setting function unit 5 judging if a part of the voice data is appropriate as interpolated voice data for interpolation in the interpolated waveform generation unit 3, selecting the voice data deemed appropriate, and setting this voice data as the interpolated voice data. If this voice waveform interpolating apparatus is used, it is possible to judge the appropriateness of a phoneme piece, for example, (i) when determining the phoneme boundary of consonants in the labeling of a synthesized voice waveform, (ii) when arranging phoneme pieces during voice synthesis, or (iii) when determining a phoneme piece in which the phoneme piece length is elongated when altering speech speed.

The voice waveform interpolating apparatus used in the latter packet communication system comprises a voice storage unit 2 storing the voice data of each normally received packet in sequence from each packet successively received, an interpolated waveform generation unit 3 which, when a part of the voice data Din is missing due to packet loss (discard or delay), interpolates the missing part with another part of the voice data Din to generate voice data Dc, a waveform combining unit 4 combining the voice data Din stored in the voice storage unit 2 with the interpolated voice data Dc from the interpolated waveform generation unit 3 replacing a part of the same, and an interpolated waveform setting function unit 5 judging if a part of the voice data Din is appropriate as interpolated voice data Dc for interpolation in the waveform generation unit 3, selecting the voice data deemed appropriate, and setting this voice data as the interpolated voice data.

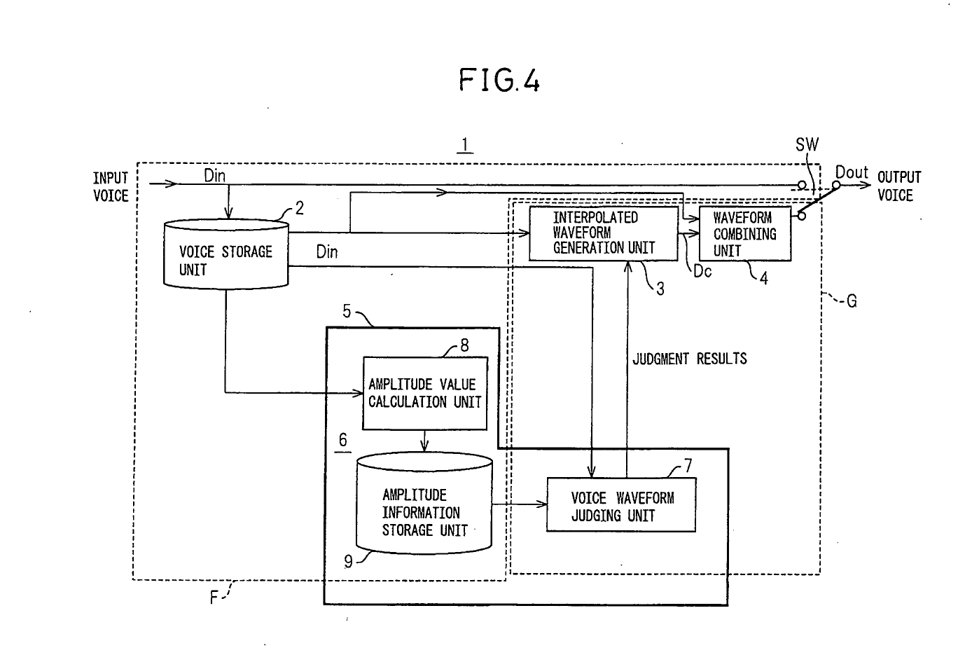

FIG. 4 is a view illustrating a first example of the above voice waveform interpolating apparatus used in a packet communication system. In this figure, the reference symbol “F” illustrates a block activated when a voice packet is normally received from a packet communication network, on the other hand, the reference symbol “G” illustrates a block activated when a missing voice packet is detected in a series of voice packets from the packet communication network. However, the configurations inside the blocks F and G are the same as the configurations illustrated in FIG. 2.

The interpolated waveform setting function unit 5 comprises an amplitude value calculation unit 8, amplitude information storage unit 9, and voice waveform judging unit 7. In packet communication in the above packet communication network, the input voice data Din is stored in the voice storage unit 2 at segments where packets are normally received. The amplitude value calculation unit 8 calculates the amplitude values in frame units from the voice data Din in the voice storage unit 2 and thereby obtains amplitude envelope information, the maximum amplitude value, the minimum amplitude value, and other amplitude information. The amplitude information storage unit 9 stores the amplitude information calculated by the amplitude value calculation unit 8.

When packet loss has occurred, the voice waveform judging unit 7 identifies the position of a waveform piece on the amplitude envelope (EV) when the waveform piece before or after the lost packet is input from the voice storage unit 2. It is judged if a waveform to be made a candidate for the interpolated waveform is at a relative minimum on the amplitude envelope (EV) or at a part Pd immediately before an unvoiced segment S. The judgment results are notified to the interpolated waveform generation unit 3.

The interpolated waveform generation unit 3 generates a waveform in the segment at which a packet was lost according to the judgment results. Further, the waveform combining unit 4 combines the voice waveform for a segment normally received and the waveform for an interpolated segment generated in the interpolated waveform generation unit 3 so that these waveforms are bridged so as to obtain a smooth output voice data Dout.

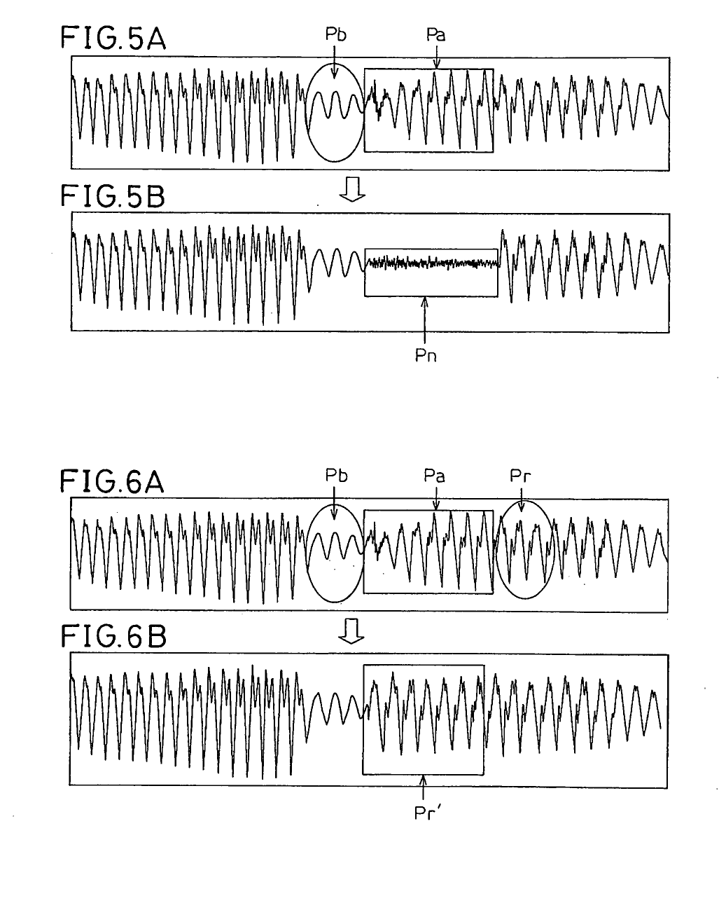

When the voice waveform judging unit 7 judges that the position on the amplitude envelope (EV) of interpolated voice data Dc as a candidate for replacing the voice loss is, at least, at the relative minimums Pc1, Pc2 of the amplitude or at the position Pd immediately before an unvoiced segment, the voice data of the related part is not used as interpolated voice data Dc. Other voice data at positions other than the voice data of the relevant part are searched for or background noise segments are searched for (refer to FIG. 5).

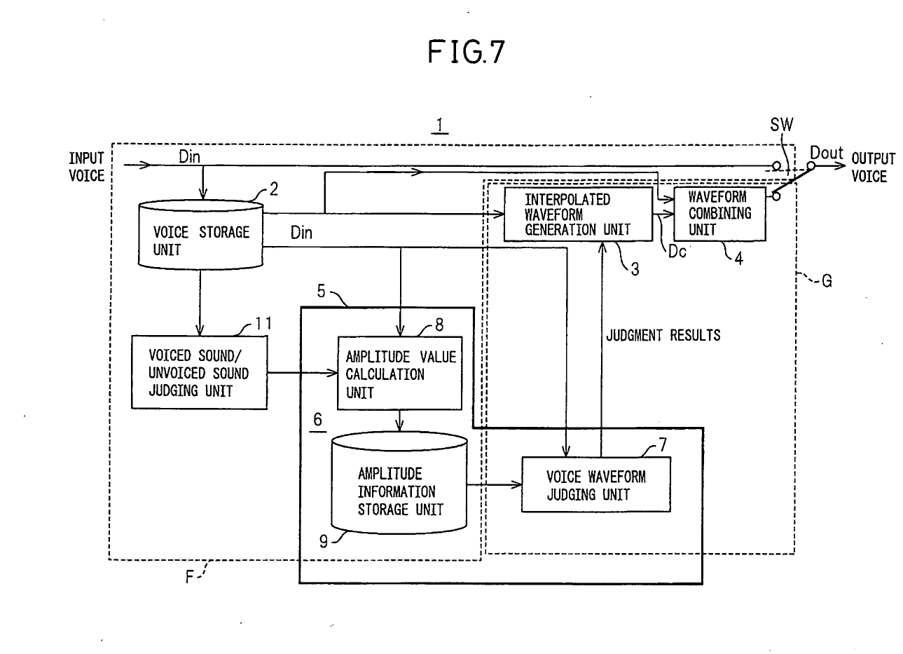

FIGS. 5A and 5B are views respectively illustrating a waveform A similar to the waveform of FIG. 14A and a voice waveform B interpolated by the background noise segment. The reference symbol Pn of FIG. 5B indicates the background noise section. When a segment immediately before a packet loss segment Pa is deemed inappropriate for waveform repetition, waveform generation by repetition is not performed. In its place, background noise data may be arranged in the packet loss segment Pa. The voice data of this background noise segment is obtained by utilizing the voice data stored in the voice storage unit 2 and referring to the judgment results of voiced sound/unvoiced sound (refer to voiced sound/unvoiced sound judging unit 11 of FIG. 7) so as to extract the voice data consisting of only the unvoiced noise. Note that, the background noise data also changes with each instant, thus the segment used is preferably voice data as close to the lost packet Pa as possible.

Further, the voice waveform judging unit 7 selects at least one of the preceding (backward) voice data sequentially appearing earlier on the time axis in voice data Din to be interpolated and succeeding (forward) voice data appearing later on the time axis in the voice data Din for candidates to become interpolated voice data for replacing the above voice loss (refer to FIG. 6).

FIGS. 6A and 6B are views illustrating respectively a waveform A similar to the waveform of FIG. 14A and a voice waveform B interpolated by the above succeeding (forward) voice data Pr. The generation of interpolated waveform illustrated in this figure is an example in which not only voice data before the lost packet but also voice data after the lost packet are judged to generate an interpolated waveform. When it is deemed that the packet immediately before the lost packet is inappropriate for use as a repeating packet while the packet immediately after the lost packet is deemed appropriate for use as a repeating packet, the voice data of the later (forward) packet deemed as appropriate is repeatedly arranged to generate the waveform Dc for the interpolated segment. However, the later voice data may be used only in cases when a slight delay of voice is allowed.

Note that, in the method of generation of the interpolated waveform, a variety of waveforms may be combined, e.g. (i) a noise waveform may be overlaid on an interpolated waveform generated by waveform repetition, and (ii) when a series of packet losses occur for a long period of time, the lost packets may be divided into a first and second half, wherein the method of generation of the waveform may be changed for the first and second half, respectively.

FIG. 7 is a view illustrating a second example of a voice waveform interpolating apparatus. The difference between this figure and FIG. 4 (first example) is that a voiced sound/unvoiced sound judging unit 11 is added. That is, the voice waveform interpolating apparatus 1 based on this second example is further provided with a voiced sound/unvoiced sound judging unit 11 which judges by dividing the voice data Din stored in the voice storage unit 2 into a voiced part and unvoiced part. Further, it calculates the maximum value of the amplitude and the fluctuation rate of the amplitude for the voice part judged to be “voiced” by the amplitude calculation unit 8 and stores the results in the amplitude information storage unit 9, while calculates the average value of the amplitude for the unvoiced part judged to be “unvoiced” by the amplitude calculation unit 8 and stores the results in the amplitude information storage unit 9. This is further explained in detail in the following.

The input voice data Din is input to the voiced sound/unvoiced sound judging unit 11 and divided into a voice segment and unvoiced segment. The next amplitude value calculation unit 8 calculates the amplitude value of the voice in frame units (for example 4 msec) from the input voice data Din stored in the voice storage unit 2. Based on the information of the amplitude envelope (EV) indicating the changes of the amplitude value in the time direction as well as the judgment results of the division by the above voiced sound/unvoiced sound judging unit 11, the maximum value and minimum value in the voiced segment and the average amplitude in the speech segment are calculated. Further, the amplitude information storage unit 9 stores both the amplitude information calculated by the amplitude value calculation unit 8 and the judgment results of the voiced sound/unvoiced sound by the unit 11.

When packet loss has occurred and the waveform parts before (or after) the lost packet are input to the voice waveform judging unit 7 from the voice storage unit 2, the positions of the above waveform parts on the amplitude envelope (EV) are identified. Judgment is performed on whether the waveform to be the candidate for interpolation is positioned at a relative minimum on the amplitude envelope (EV) or whether it is positioned at a part immediately before an unvoiced segment S. An example of an actual voice waveform is as illustrated in the above FIG. 5.

If introducing the above voiced sound/unvoiced sound judging unit 11, the advantages are gained that the accuracy of calculation of the maximum value, minimum value, and relative minimum increases and the calculation load at the amplitude value calculation unit 8 becomes lighter. In the following, the operation flow when introducing the voiced sound/unvoiced sound judging unit 11 will be explained.

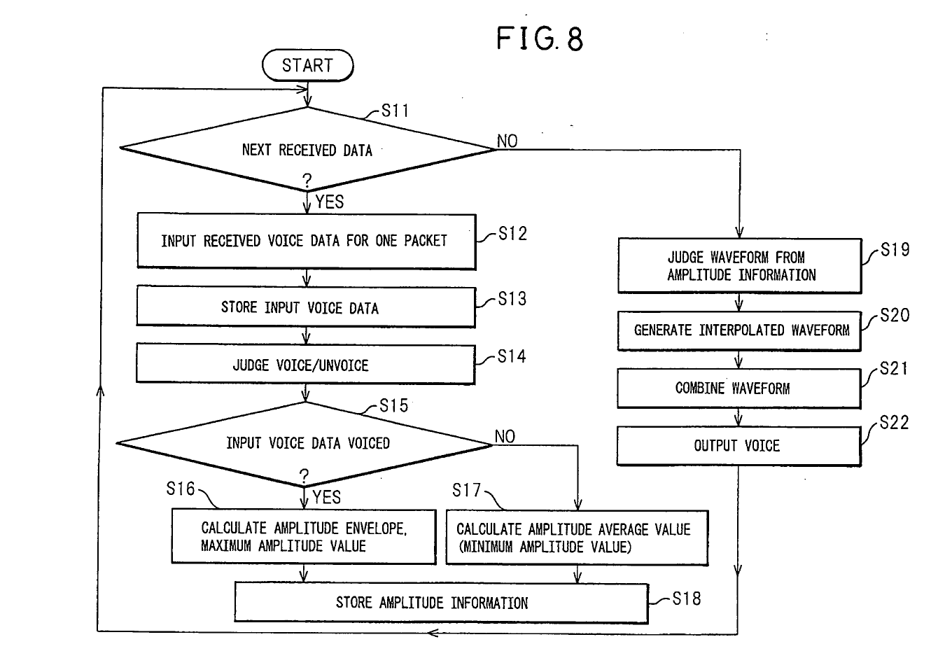

FIG. 8 is a flowchart illustrating the operations of the voice waveform interpolating apparatus depicted in FIG. 7. In FIG. 8,

Step S11: It is judged if a packet is normally received.

Step S12: If the packet is normally received (YES), that one packet data (voice data) is fetched.

Step S13: The input voice data Din is stored in the voice storage unit 2.

Step S14: Further, the above voiced sound/unvoiced sound judging unit 11 performs processing for dividing the voice data Din into voiced parts and unvoiced parts,

Step S15: Judgment is performed based on the results of the division.

Step S16: If it is deemed to be “voiced” by the above judgment (YES), the amplitude envelope (EV) of the voice data and the maximum value of the amplitude are calculated.

Step S17: On the other hand, if it is deemed to be “unvoiced” by the above judgment, the average value of the unvoiced amplitude (that is, the minimum value of the unvoiced amplitude) is calculated.

Step S18: The calculated data is stored in the amplitude information storage unit 9.

Step S19: At the above initial step S11, if it is judged that a packet was not normally received (packet loss), judgment by the above waveform judging unit 7 is performed based on the amplitude information stored at step S18.

Step S20: As in the above, interpolated voice data Dc is generated by the interpolated waveform generation unit 3.

Step S21: Further, the input voice data Din and interpolated voice data Dc are smoothly combined by the waveform combining unit 4.

Step S22: The output voice data Dout is obtained. Here, the above step S19 is explained in further detail.

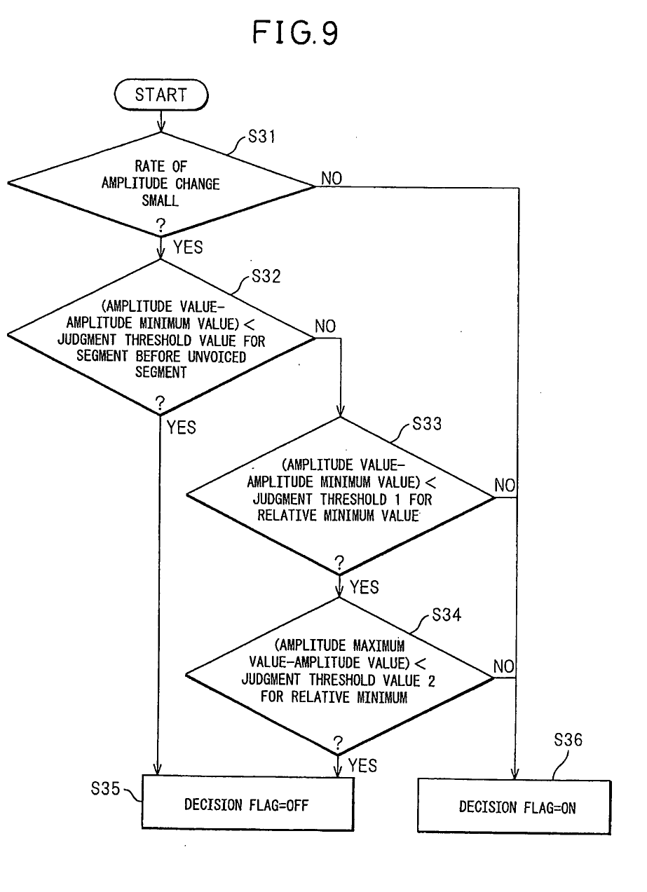

FIG. 9 is a flowchart illustrating step S19 of FIG. 8 in further detail. In this figure,

Step S31: The voice waveform judging unit 7 examines the rate of amplitude change at the position, on the amplitude envelope EV (FIG. 3), of the voice to be a candidate for the interpolation. In places where the rates of amplitude change are small, parts which are inappropriate for use as the interpolated waveforms may be included.

Step S32: However, judgment of parts which are inappropriate for use as interpolated waveforms is performed by the following three steps with respect to the parts having small rates of amplitude change. First, if an (amplitude value-(minus)minimum amplitude value)<threshold judging as a segment immediately before an unvoiced segment, it is immediately deemed to be inappropriate as an interpolated waveform and then the decision flag is turned OFF (unusable).

Step S33: If the above inequality does not stand (NO), next, it is examined whether the inequality of (amplitude value-minimum amplitude value)<threshold 1 judging as relative minimum stands.

Step S34: If the inequality stands (YES), further, it is examined whether the inequality of (maximum amplitude value-amplitude value)<threshold 2 judging as relative minimum stands.

Step S35: If the inequality stands (YES), the use of the voice data as an interpolated waveform is ultimately disabled (decision flag=OFF). That is, referring to the above FIG. 3, when for example it is within the amplitude range “TH” of this figure, the related waveform is unusable.

Step S36: Accordingly, if any of the judgment results in the above step S31, S33, and S34 is “NO”, the voice data is permitted to be used as an interpolated waveform (decision flag=ON).

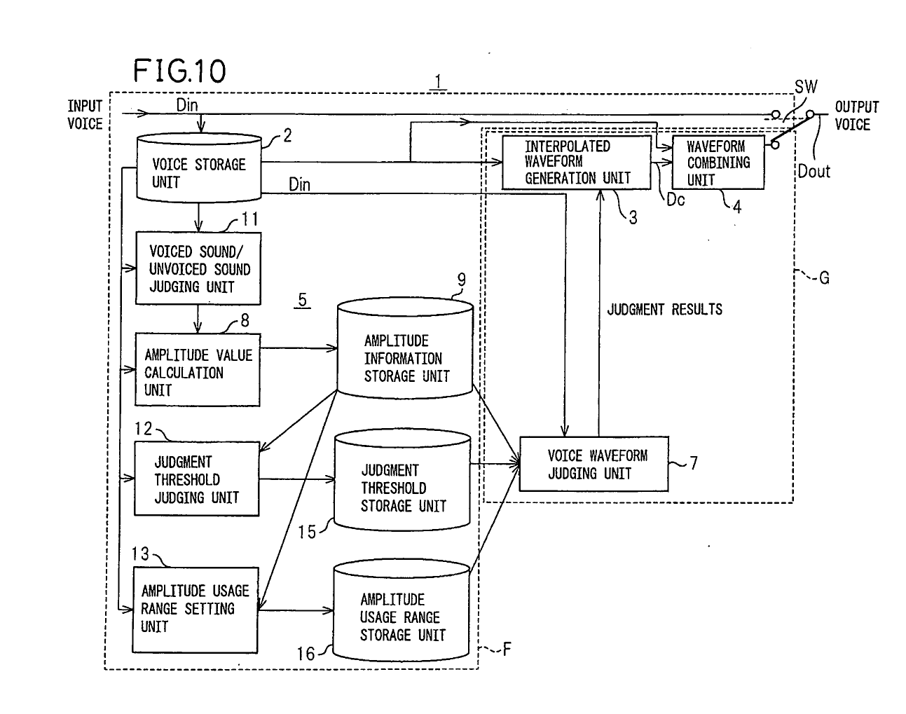

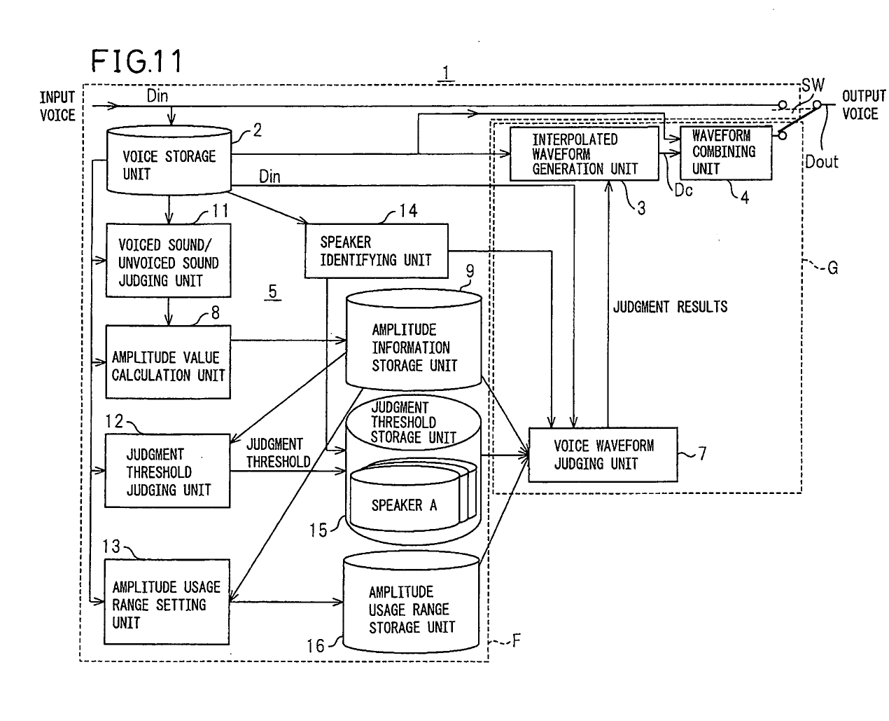

FIG. 10 is a view illustrating a third example of a voice waveform interpolating apparatus, and FIG. 11 is a view illustrating a fourth example of a voice waveform interpolating apparatus.

In summary, the third example and the fourth example illustrate a voice waveform interpolating apparatus further provided with a judgment threshold setting unit 12 setting the amplitude judgment threshold T1 for judging the appropriateness of the interpolated voice data Dc in the voice waveform judging unit 7 based on the voice data Din stored in the voice storage unit 2 and the amplitude information stored in the amplitude information storage unit 9. The above fourth example further illustrate a voice waveform interpolating apparatus (FIG. 11) which is further provided with a speaker identifying unit 14 for setting the above amplitude judgment threshold T1 for each of the identified speaker, and the above third and fourth examples further illustrate a voice waveform interpolating apparatus (FIG. 10 and FIG. 11) which is further provided with an amplitude usage range setting unit 13, which amplitude usage range setting unit 13 sets what amplitude range is to be used when using the amplitude information in the voice waveform judging unit 7.

The judgment threshold setting unit 12, to cope with this constantly changing voice data Din, calculates the judgment threshold T1 when judging the voice waveform based on the voice data of the voice storage unit 2 and the amplitude information of the amplitude information storage unit 9 and stores this calculated value T1 in the judgment threshold storage unit 15. Note that, specific examples of each judgment threshold are illustrated in the following.

Breathing group end judgment threshold=(unvoiced segment)amplitude average value×1.2

Relative minimum judgment threshold 1=(voiced segment)minimum amplitude value×1.2 (refer to S33 of FIG. 9)

Relative minimum judgment threshold 2=(voiced segment)maximum amplitude value×0.8 (refer to S34 of FIG. 9)

On the other hand, the amplitude usage range setting unit 13 of FIG. 10 and FIG. 11 sets the usage range of the amplitude information used in the voice waveform judging unit 7. With regards to the method of setting the usage range for the amplitude information, there may be considered (i) setting this as a range of time, (ii) setting the unvoiced sound segment between two unvoiced segments as the amplitude usage range by referring to the judgment results of the voiced sound/unvoiced sound judging unit 11, and (iii) setting one breathing group as the amplitude usage range by referring to the judgment results of the voiced sound/unvoiced sound judging unit 11.

Explaining the above (i) to (iii) in further detail:

(i) Time is specified, for example, 3 seconds before a packet loss.

(ii) A segment between unvoiced segments is set to be the amplitude usage range based on the results of judgment of the voiced sound/unvoiced sound judging unit 11, however, the unvoiced segment includes not only segments of only background noise, but also those with frictional sound (for example consonant parts of sound “sa”) and bursting sounds (for example consonant parts of sound “ta”).

(iii) The range of one breath group, that is, the range of talking by one breath, is set to be the amplitude usage range based on the judgment results of the voiced sound/unvoiced sound judging unit 11.

The voice waveform judging unit 7 of FIG. 10 and FIG. 11 uses the amplitude information in the amplitude information storage unit 9, the judgment threshold in the judgment threshold storage unit 15, and the amplitude usage range in the amplitude usage range storage unit 16 to judge if the voice waveform is a repeatedly usable voice waveform.

Further, the amplitude information within the amplitude usable range stored in the amplitude usage range storage unit 16 is obtained from the amplitude information storage unit 9 to calculate the minimum amplitude value, maximum amplitude value, etc. Further, the judgment threshold in the judgment threshold storage unit 15 is used for judgment, however, the judgment method at this time is as illustrated in the flowchart in FIG. 9.

The speaker identifying unit 14 in the fourth example of FIG. 11 identifies the speaker based on the voice data Din of the voice storage unit 2. In the identification method of the speaker, identification may be performed by converting the voice data into frequency by FFT (Fast Fourier Transform) and examining the average frequency and formant. The rate of amplitude change when moving from a vowel to a consonant differs and further the difference between the maximum amplitude value and the minimum amplitude value differs for each speaker. Here, the judgment threshold storage unit 15 stores threshold information for each speaker.

When voice packet loss occurs, speaker identification is performed from the voice data of the voice storage unit 2. The voice waveform judging unit 7 uses the threshold information for each speaker stored in the judgment threshold storage unit 15 so as to judge the waveform. At that time, by using thresholds by speaker, the judgment performance may be further improved.

Different methods of waveform interpolation are considered as explained above. For example, there are the methods illustrated in the above FIG. 5 and FIG. 6, however, one further aspect is illustrated.

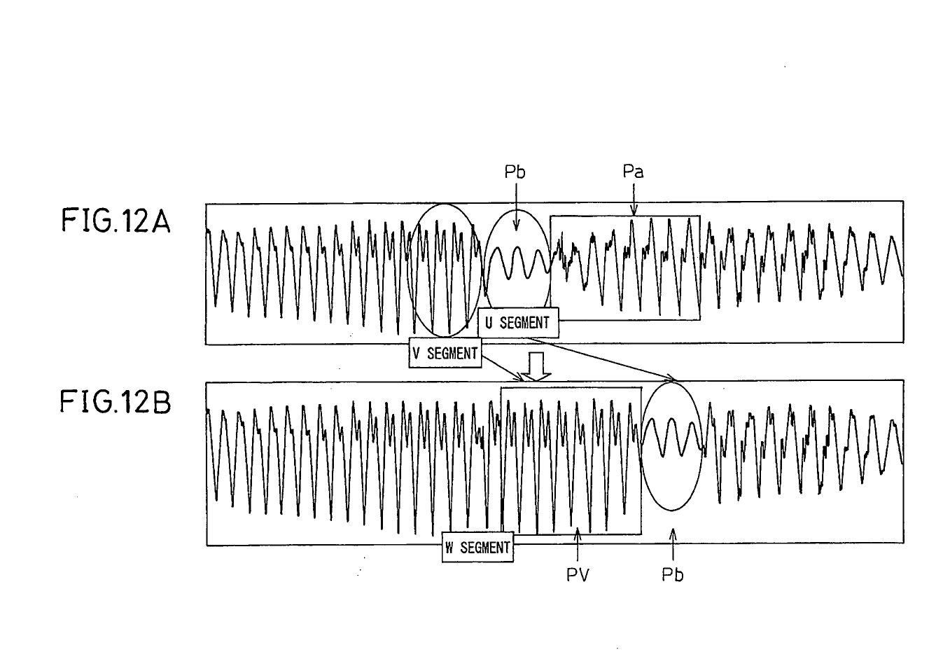

FIGS. 12A and 12B are views respectively illustrating an example A in which the waveform of FIG. 14A is transformed and a voice waveform B interpolated by using the preceding (backward) voice data. The waveform generation in FIGS. 12A and 12B are examples in which only the voice waveform data preceding a lost packet Pa is used for the interpolation segment (W segment). When it is deemed that the voice waveform of the segment (U segment) immediately before the packet loss segment (Pa) is inappropriate for use as waveform repetition, judgment of the further previous (backward) packet (V segment) is performed. As a result, when the V segment is deemed to be appropriate for use as waveform repetition, the waveform of this V segment is repeatedly arranged at the W segment, and the waveform of the U segment is further arranged in continuation to generate a waveform PV of the interpolated segment W.

As a further separate aspect, in cases when using voice waveform data after the lost packet, when it is deemed that the segment immediately after the lost packet segment is inappropriate for use as waveform repetition, judgment of a further later (forward) packet is performed, and when it is deemed that it is appropriate for repeated use, first, the waveform of the above segmented deemed appropriate for repeated use is arranged only once, and the waveform of the above later (forward) packet is repeatedly used to connect it to generate the waveform of the interpolated segment W.

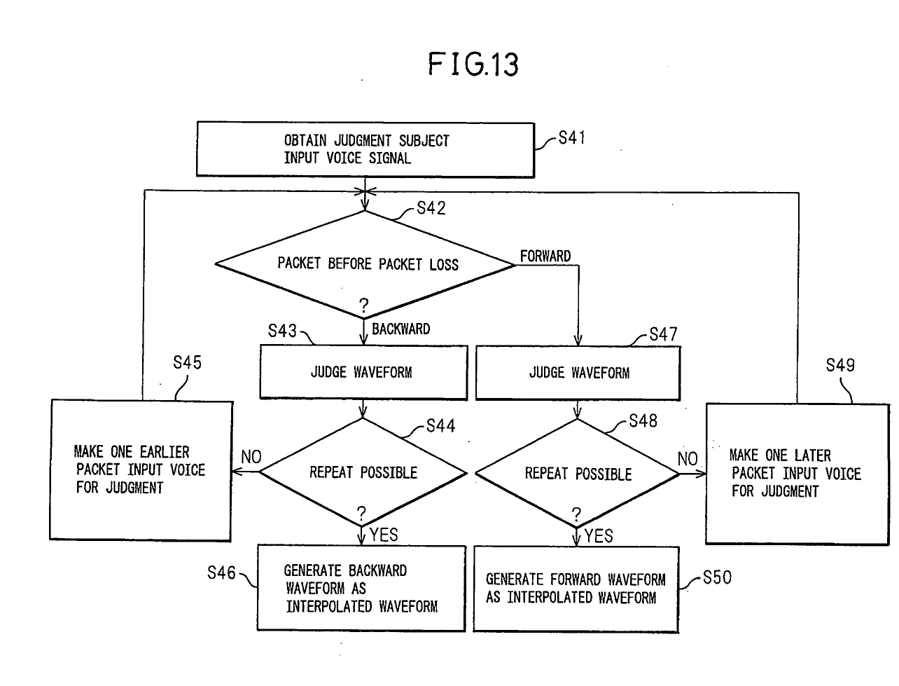

FIG. 13 is a flowchart illustrating the operations when performing waveform interpolation such as illustrated in FIGS. 6A and 6B and FIGS. 12A and 12B. In this figure,

Step S41: An input voice signal (Din), the subject of judgment, is obtained in the interpolated waveform setting function unit 5.

Step S42: It is judged if an input packet consisting the input voice signal is a packet before (backward) or after (forward) the lost packet.

Step S43: If it is a packet before (backward) the lost packet, that waveform (refer to the U segment of FIG. 12A) is judged.

Step S44: If the preceding (backward) packet is judged inappropriate for repeated use for an interpolated segment based on the judgment results (NO),

Step S45: One further previous (backward) packet (V segment of FIG. 12A) is covered by the judgment, and similar operations are repeated.

Step S46: At step S44, if it is deemed appropriate for repeated use in the interpolated segment (YES), the waveform at the interpolated segment is generated with the preceding (backward) waveform deemed appropriate.

Further, a different method of interpolation is as follows.

Step S47: At the above step S42, it is judged if an input packet consisting the input voice signal is a packet before (backward) or after a (forward) lost packet, and if the packet is a later (forward) packet, the judgment for its waveform (refer to Pr of FIG. 6A) is achieved.

Step S48: If the later packet is deemed inappropriate for repeated use in the interpolated segment based on the judgment results (NO),

Step S49: One further later (forward) packet is covered by the judgment and similar operations are performed.

Step S50: At step S48, if it is deemed appropriate for repeated use in an interpolated segment (YES), the waveform at the interpolated segment is generated with a later (forward) waveform deemed appropriate.

The voice waveform interpolating apparatus explained above may be expressed as the steps of a method. That is, it is a voice waveform interpolating method generating voice data in which part of the stored voice data Din is interpolated using another part of the voice data, comprising a (i) first step of storing the voice data Din, (ii) a second step judging if a part of the voice data is appropriate as interpolated voice data Dc for interpolation, selecting the voice data deemed appropriate, and setting it as the interpolated voice data Dc, and (iii) a third step combining the voice data stored in the first step (i) with the interpolated voice data Dc set at the second step (ii).

Further, it is a voice waveform interpolating method including in the second step (ii) an analysis step analyzing the amplitude information for the voice data Din stored in the first step (i) and a voice waveform judging step judging its appropriateness for use as the interpolated voice data Dc based on the analysis results.

Further, the above embodiment may be expressed as a computer-readable recording medium storing a voice waveform interpolating program, in which the program is a voice waveform interpolating program generating voice data in which a part of the voice data Din stored in the computer is interpolated with another part of the voice data and executing a (i) first step of storing the voice data Din, (ii) a second step judging if a part of the voice data is appropriate as interpolated voice data Dc for interpolation, selecting the voice data deemed appropriate, and setting it as the interpolated voice data Dc, and (iii) a third step combining the voice data stored in the first step (i) with the interpolated voice data Dc set at the second step (ii).

### DESCRIPTION OF NOTATIONS

1 voice waveform interpolating apparatus
2 voice storage unit
3 interpolated waveform generation unit
4 waveform combining unit
5 interpolated waveform setting function unit
6 amplitude information analyzing part
7 voice waveform judging unit
8 amplitude value calculation unit
9 amplitude information storage unit
11 voiced sound/unvoiced sound judging unit
12 judgment threshold judging unit
13 amplitude usage range setting unit
14 speaker identifying unit
15 judgment threshold storage unit
16 amplitude usage range storage unit

What is claimed is:

1. A voice waveform interpolating apparatus comprising:
a voice storage unit storing voice data;
an interpolated waveform generation unit interpolating part of the voice data by another part of the voice data to generate voice data;
a waveform combining unit combining the voice data from the voice storage unit with the interpolated voice data from the interpolated waveform generation unit replacing part of the same; and
an interpolated waveform setting function unit judging if a part of the voice data is appropriate as interpolated voice data for interpolation in the interpolated waveform generation unit, selecting the voice data deemed appropriate, and setting it as the interpolated voice data.

2. A voice waveform interpolating apparatus as set forth in claim 1, wherein the interpolated waveform setting function unit includes
an amplitude information analyzing part analyzing amplitude information of the voice data from the voice storage unit and
a voice waveform judging unit judging the appropriateness as interpolated voice data based on the analysis results.

3. A voice waveform interpolating apparatus as set forth in claim 1, wherein
the amplitude information analyzing part comprises an amplitude value calculation unit calculating an amplitude value of the voice data to obtain the amplitude value of a time direction and an amplitude information storage unit temporarily storing the calculated amplitude value as amplitude information, and
the voice waveform judging unit judges the appropriateness as interpolated voice data according to the position on the amplitude envelope identified from the amplitude information of the time direction.

4. A voice waveform interpolating apparatus as set forth in claim 3, wherein when the voice waveform judging unit judges that the position on the amplitude envelope of interpolated voice data as a candidate replacing voice loss is, at least, at relative minimums of the amplitude or at the position immediately before an unvoiced segment, the voice data of the related part is not used as interpolated voice data, but other voice data at positions other than the voice data of the related part are searched for or background noise segments are searched for.

5. A voice waveform interpolating apparatus as set forth in claim 4, wherein the voice waveform judging unit selects at least one of the preceding (backward) voice data sequentially appearing earlier on the time axis in voice data to be interpolated and succeeding (forward) voice data appearing later on the time axis in the voice data for a candidate to become interpolated voice data replacing the voice loss.

6. A voice waveform interpolating apparatus as set forth in claim 3, further comprising
a voiced sound/unvoiced sound judging unit judging the voice by dividing the voice data stored in the voice storage unit into a voiced part and unvoiced part and
calculating the maximum value of the amplitude and the fluctuation rate of the amplitude for the voice part judged to be “voiced” by the amplitude calculation unit and the results are stored in the amplitude information storage unit, while calculating the average value of the amplitude for the unvoiced part judged to be “unvoiced” by the amplitude calculation unit and storing the results in the amplitude information storage unit.

7. A voice waveform interpolating apparatus as set forth in claim 3, further comprising a judgment threshold setting unit setting an amplitude judgment threshold when judging the appropriateness of the interpolated voice data by the voice waveform judging unit based on the voice data stored in the voice storage unit and the amplitude information stored in the amplitude information storage unit.

8. A voice waveform interpolating apparatus as set forth in claim 7, further comprising a speaker identifying unit setting the amplitude judgment threshold for each identified speaker.

9. A voice waveform interpolating apparatus as set forth in claim 6, further comprising an amplitude usage range setting unit, the amplitude usage range setting unit setting what range of the amplitude information is to be used by the voice waveform judging unit.

10. A voice waveform interpolating apparatus as set forth in claim 9, wherein the amplitude usage range is set as a range of time.

11. A voice waveform interpolating apparatus as set forth in claim 9, wherein the amplitude usage range refers to the judgment results of the voiced sound/unvoiced sound judging unit and sets a voiced sound segment between two unvoiced sound segments as the usage range of the amplitude.

12. A voice waveform interpolating apparatus as set forth in claim 9, wherein the amplitude usage range refers to the judgment results of the voiced sound/unvoiced sound judging unit and sets one breath group as the usage range of the amplitude.

13. A voice waveform interpolating apparatus used in a packet communication system, comprising
a voice storage unit storing in sequence voice data of each normally received packet among successively received packets,
an interpolated waveform generation unit interpolating a missing part of voice data by another part of the voice data when part of the voice data is missing due to packet loss so as to generate voice data,
a waveform combining unit combining voice data stored in the voice storage unit with the interpolated voice data from the interpolated waveform generation unit replacing part of the same, and
an interpolated waveform setting function unit judging if the part of the voice data is appropriate as interpolated voice data for interpolation in the interpolated waveform generation unit, selecting the voice data deemed appropriate, and setting it as the interpolated voice data.

14. A voice waveform interpolating apparatus used in a voice editing or processing system, comprising
a voice storage unit storing a plurality of phoneme pieces,
an interpolated waveform generation unit interpolating part of a series of voice data by repeated use of a phoneme piece so as to generate voice data,
a waveform combining unit combining the voice data stored in the voice storage unit with the interpolated voice data from the interpolated waveform generation unit replacing part of the same, and
an interpolated waveform setting function unit judging if the part of the voice data is appropriate as interpolated voice data for interpolation in the interpolated waveform generation unit, selecting the voice data deemed appropriate, and setting it as the interpolated voice data.

15. A voice waveform interpolating method interpolating part of stored voice data by another part of the voice data so as to generate voice data, comprising:
storing the voice data,
judging if the part of the voice data is appropriate as interpolated voice data for interpolation in the interpolated waveform generation unit, selecting the voice data deemed appropriate, and setting it as the interpolated voice data, and
combining the stored voice data with the set interpolated voice data.

16. A voice waveform interpolating method as set forth in claim 15, wherein the judging and setting step comprises
analyzing the amplitude information for the stored voice data and
judging the appropriateness as the interpolated voice data based on the analysis results.

17. A computer readable recording medium storing a voice waveform interpolating program causing a computer to interpolate part of stored voice data by another part of the voice data so as to generate voice data, said program comprising:
storing the voice data,
judging if the part of the voice data is appropriate as interpolated voice data for interpolation in the interpolated waveform generation unit, selecting the voice data deemed appropriate, and setting it as the interpolated voice data, and
combining the stored voice data with the set interpolated voice data.
